(19) United States
(12) Patent Application Publication
(10) Pub. No.: US 2011/0282499 A1
(43) Pub. Date: Nov. 17, 2011

(54) CONTROL FOR INDICATING AVAILABLE HOT FLUID SUPPLY

(76) Inventor: Chetan A. Sowani, Dhankawadi (IN)

(21) Appl. No.: 13/106,001

(22) Filed: May 12, 2011

(30) Foreign Application Priority Data
May 12, 2010 (IN) 1494/MUM/2010

(51) Int. Cl. F24H 9/20; G05D 7/06

(52) U.S. Cl. 700/282; 122/14.1

(57) ABSTRACT

A fluid heater and a method for evaluating and displaying hot fluid supply time are disclosed. The system includes a fluid container, a controlling unit, a computational element, and a display means. The fluid container includes a cold fluid inlet means, a hot fluid outlet means, a first heating element, a second heating element, a first temperature sensor and a second temperature sensor. The controlling unit is adapted to selectively activate and deactivate one of the first heating element and the second heating element based on the inputs received from the said sensors. The computational element is adapted to compute the hot fluid supply time at a pre-determined set temperature based on at least one input received from said sensors, capacity of said fluid container, and flow rate of fluid to and from said fluid container. The display means is adapted to display the computed supply time.

### CROSS-REFERENCE TO RELATED APPLICATIONS

This application claims the benefit and priority of Indian Patent Application No. 1494/MUM/2010, filed May 12, 2010 entitled “Fluid Heater and Method for Evaluating and Displaying Hot Fluid Supply Time”. The entire disclosure of the above application is incorporated herein by reference.

### FIELD

The present disclosure relates to systems and methods for heating the fluids, more particularly, the present disclosure relates to a fluid heater and a method for heating the fluid above its initial temperature.

### BACKGROUND

This section provides background information related to the present disclosure which is not necessarily prior art.

Storage water heaters may be utilized domestically and industrially in various applications. Domestically, the hot water is used for bathing, cleaning, cooking, space heating, and the like. Generally, for domestic use, a storage water heater is used for generation of hot water. The storage water heater has inherent limitation that the storage water heater can not supply hot water continuously. After a particular period of time, the storage water heater runs out of hot water. In some storage water heaters, a temperature set point may be adjusted by a user. In such temperature settable storage type water heaters, the temperature set point may go down eventually whenever there is hot water consumption for longer period of time. Accordingly, in such storage water heaters, the user cannot ascertain the time duration for which the user is getting hot water.

### SUMMARY

This section provides a general summary of the disclosure, and is not a comprehensive disclosure of its full scope or all of its features.

In accordance with one aspect of the present disclosure, there is provided a fluid heater for determining and displaying hot fluid supply time. The fluid heater includes a fluid container, a controlling unit, and a display means. The fluid container includes a cold fluid inlet, a hot fluid outlet, a first heating element, a second heating element, a first temperature sensor and a second temperature sensor. The cold fluid inlet is adapted for supplying cold fluid to a bottom portion of the container. The hot fluid outlet is adapted for discharging the hot fluid from a top portion of the container. The first heating element is disposed within the container and spaced from the bottom of the container. The second heating element is disposed within the container and spaced from the top of the container. The first temperature sensor is configured to provide an output indicative of the temperature of water that is in proximity to the first heating element. The second temperature sensor is configured to provide an output indicative of the temperature of water that is in proximity to the second heating element. The controlling unit is configured to receive inputs from the first temperature sensor and the second temperature sensor. The controlling unit is configured to selectively activate and deactivate one of the first heating element and the second heating element based on the outputs from the first temperature sensor and the second temperature sensor. The controlling unit is configured to determine a supply time during which fluid drawn from the container is at or above a pre-determined set temperature based on at least one output from the first or second temperature sensors, the capacity of the fluid container, and the flow rate of fluid to or from the fluid container. The display means is communicably coupled to the controlling unit, and is configured to display the determined supply time.

Some embodiments may further include a third sensor that is configured to provide an output indicative of the temperature of water within the container that is between the first temperature sensor and the second temperature sensor. In other embodiments, the cold fluid inlet may include a fourth sensor that provides an output indicative of the cold fluid flow rate into the container, and the hot fluid outlet may include a fifth sensor that provides an output indicative of the hot fluid flow rate from the container. The fourth and fifth sensors may be a turbine flow sensor, for example. Preferably, the fluid heater is a storage type water heater.

In one preferred embodiment, the display means includes a warning indicating means for providing a warning signal when the fluid container contains minimum amount of hot fluid. The display means may be liquid crystal Display (LCD), or alternatively a light-emitting diode (LED) or a cathode ray tube (CRT).

In accordance with another aspect of the present disclosure, there is provided a method for determining and displaying a hot fluid supply time associated with a fluid heater. The method includes the steps of supplying cold fluid to a bottom portion of a fluid container, heating the fluid contained inside the container to a pre-determined set temperature by a first heating element and a second heating element, and selectively activating and deactivating one of the first heating element and the second heating element based on the inputs received from a first temperature sensor and a second temperature sensor by a controlling unit. The method further includes the step of determining a supply time during which fluid drawn from the container is at or above a pre-determined set temperature, based on at least one input received from the first temperature sensor and the second temperature sensor, the capacity of the fluid container, and the flow rate of fluid to or from the fluid container, as determined by the controlling unit. The method further includes the step of displaying the determined supply time on a display means.

The method may further include the step of providing a warning signal when the fluid container contains minimum amount of hot fluid that is at or above a pre-determined set temperature.

The method may further include the step of obtaining from the third temperature sensor an output that is indicative of the temperature of water within the container between the first temperature sensor and the second temperature sensor. The method may further include the step of determining from the output of the fourth sensor the cold fluid flow rate into the fluid container.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 illustrates a block diagram of a fluid heater for determining and displaying hot fluid supply time, in accordance with one embodiment of the present disclosure;

FIG. 2 illustrates a perspective view depicting a fluid container of the fluid heater shown in FIG. 1, which is communicably coupled to a display means of the fluid heater shown in FIG. 1;

FIG. 3 illustrates a schematic representation of the fluid container of FIG. 2;

FIG. 4a illustrates a schematic representation of a display screen of the display means of FIG. 2, which depicts a minimum amount of time in which a user may be supplied with hot fluid;

FIG. 4b illustrates a schematic representation of the display screen of the display means shown in FIG. 2, which depicts no availability of hot fluid inside the fluid heater;

FIG. 4c illustrates a schematic representation of the display screen of the display means of FIG. 2, which depicts a half-way mark of the hot fluid supply time;

FIG. 4d illustrates a schematic representation of the display screen of the display means of FIG. 2, in accordance with another embodiment of the present disclosure;

FIG. 4e illustrates a schematic representation of the display screen of the display means of FIG. 2, in accordance with yet another embodiment of the present disclosure;

FIG. 4f illustrates a schematic representation of the display screen of FIG. 4e, which depicts the hot fluid supply time;

FIG. 4g illustrates a schematic representation of the display screen of FIG. 4e, which depicts a minimum amount of time during which a user may be supplied with hot fluid;

FIG. 4h illustrates a schematic representation of the display screen of FIG. 4e, which depicts no availability of hot fluid inside the fluid heater;

FIG. 4i illustrates a schematic representation of the display screen of FIG. 4e, which depicts the hot fluid supply time for standby mode during which no fluid is drawn;

FIG. 5 illustrates a schematic representation of the fluid container of the fluid heater of FIG. 1, which depicts a fourth sensor in accordance with yet another embodiment of the present disclosure;

FIG. 6 illustrates a flow chart depicting a method for determining and displaying hot fluid supply time from a fluid heater, in accordance with one embodiment of the present disclosure;

FIG. 7 illustrates a flow chart depicting operation of the fluid heater of FIG. 1; and

FIG. 8 illustrates a table depicting hot fluid supply time amounts under various operating conditions.

Corresponding reference numerals indicate corresponding parts throughout the several views of the drawings.

### DETAILED DESCRIPTION

Example embodiments will now be described more fully with reference to the accompanying drawings.

According to one aspect of the present disclosure, a system is provided for determining and displaying a hot fluid supply time, for a fluid heater for heating fluids, such as water, above its initial temperature. More specifically, the system is configured to provide a supply time indication that enables the user to plan further course of action based on the supply time during which hot fluid, such as hot water that is at or above a pre-determined temperature, is available to the user. The system is adapted to provide a user at least one of a visual indication, a sound indication or other suitable indication, for depicting the supply time duration in which the supply of hot fluid at or above a pre-determined set temperature is available to a user. The system of the present disclosure assists the user in deciding whether to start and continue using hot fluid, or to reduce the output flow rate of hot fluid, or wait until hot fluid supply increases. More specifically, the system of the present disclosure may be useful during times such as winter season, before taking baths, and the like.

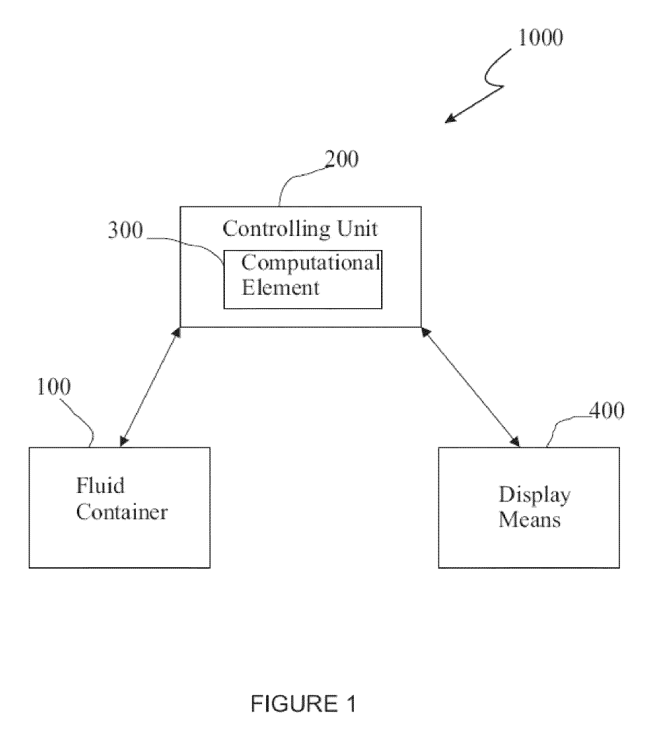

Referring to FIG. 1, a block diagram is shown depicting a system for determining and displaying hot fluid supply time. In one embodiment of the present disclosure, the system includes a fluid heater that is a storage type water heater. However, the system is not limited to any particular type of water heater, and the system may also be used for various other fluid heaters known in the art. The fluid heater 1000 includes a fluid container 100, a controlling unit 200, and a display means 400. The controlling unit 200 may include a computational element 300.

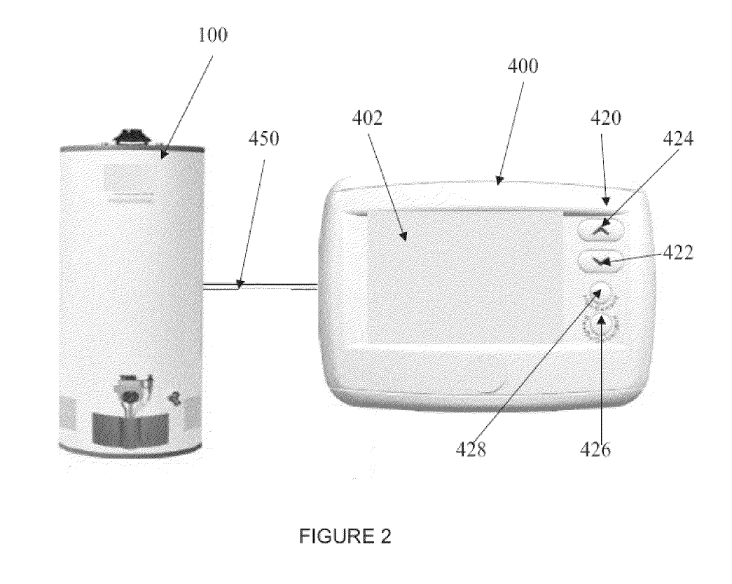

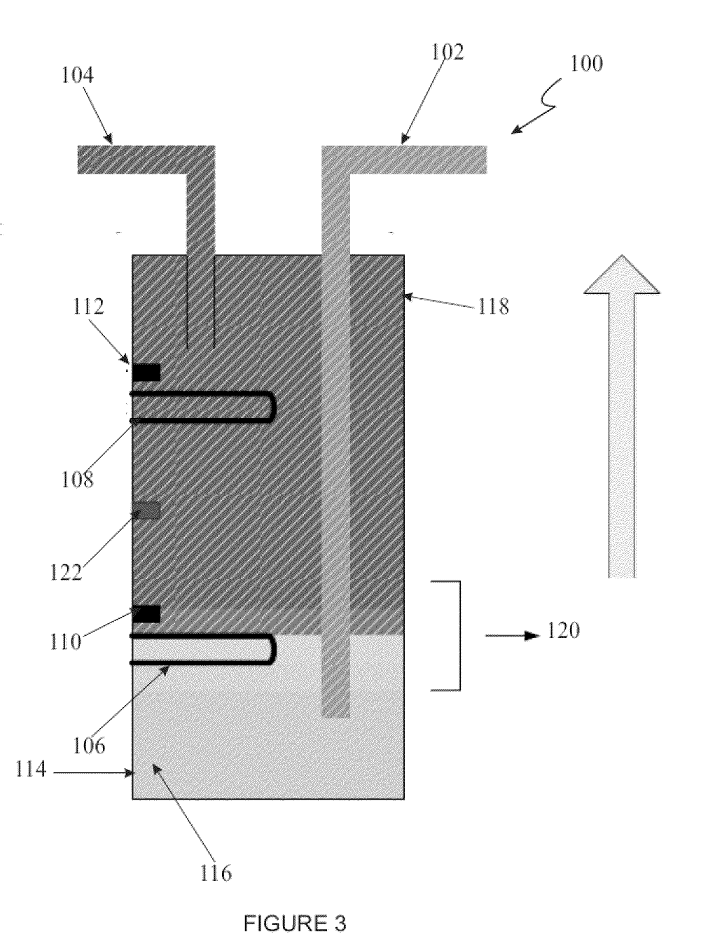

Referring to FIGS. 2-3, a schematic representation of the fluid container 100 is depicted. The fluid container 100 is adapted to be fully filled with fluid. The fluid, such as water, contained inside the fluid container 100 may be heated by various energy sources such fossil fuels, electricity, solar energy or the like. The fluid container 100 may be used for providing hot fluids to a user for performing various operations, such as, bathing, cleaning, cooking and the like.

More specifically, referring to FIG. 3, the fluid container 100 includes a cold fluid inlet 102, a hot fluid outlet 104, a first heating element 106, a second heating element 108, a first temperature sensor 110, and a second temperature sensor 112. The cold fluid inlet 102 is adapted for supplying cold fluid (e.g., fluid that is not heated) to a bottom portion 114 of the container 100. More specifically, the cold fluid inlet 102 is adapted to supply cold fluid (e.g., fluid that is not heated) to the inside 116 of the fluid container 100. The cold fluid inlet 102 is preferably supplied under pressure, such that when hot fluid is drawn from a top portion 118, the same amount of cold fluid enters the bottom portion 114. The hot fluid outlet 104 is adapted for discharging the hot fluid contained inside the fluid container 100. More specifically, the hot fluid outlet 104 is adapted for discharging the hot fluid from the top portion 118 of the fluid container 100.

The first heating element 106 is disposed within the container 100 and spaced from the bottom portion 114. The first heating element 106 is adapted to heat the fluid contained inside the fluid container 100, and more specifically adapted to heat a portion of fluid contained in the bottom portion 114 of the fluid container 100. The first heating element 106 is preferably activated for heating when the fluid temperature drops below a pre-determined set temperature, where the pre-determined set temperature may be set by the user based on the user's requirement.

The second heating element 108 is disposed within the container 100 and spaced from the top portion 118. The second heating element 108 is adapted to heat the fluid contained inside the fluid container 100, and more specifically adapted to heat a portion of fluid contained in the top portion 118 of the fluid container 100. The second heating element 108 is preferably activated for heating when the fluid temperature drops below the pre-determined set temperature. More specifically, the second heating element 108 and the first heating element 106 are adapted to be deactivated or turned off, when the fluid attains the pre-determined set temperature.

The first temperature sensor 110 may be positioned inside 116 the container 100 in proximity to the first heating element 106, or alternatively may be disposed on an exterior surface of the container near the first heating element 106. The first temperature sensor 110 is configured to provide an output indicative of the temperature of water that is in proximity to the first heating element 106. In one embodiment of the present disclosure, activation and de-activation of the first heating element 106 is based in part on the output of the first temperature sensor 110 that is indicative of temperature of the fluid in the container 100. The movement of a thermal plane 120 in the container 100 may also be detected from the output of the first temperature sensor 110 indicative of temperature of the fluid in the container 100. The thermal plane 120 is formed due to mixing and/or draw of the hot fluid and supply of the cold fluid. The thermal plane 120 tends to move upward when the hot fluid is discharged out of the container 100. In other words, when the hot fluid is discharged out of the fluid container 100, the thermal plane 120 is formed between the diminishing amount of hot fluid and the inlet supply of cold fluid.

The second temperature sensor 112 may be positioned inside the fluid container 100 in proximity to the second heating element 108, or alternatively may be disposed on an exterior surface of the container near the second heating element 108. The second temperature sensor 112 is configured to provide an output indicative of the temperature of water that is in proximity to the second heating element 108. Additionally, movement of a thermal plane 120 in the container 100 may also be detected from the output of the second temperature sensor 112 that is indicative of temperature of the fluid in the container 100. Moreover, activation and de-activation of the second heating element 108 is based in part on the output of the second temperature sensor 112 that is indicative of temperature of the fluid in the container 100.

In one embodiment of the present disclosure, the container 100 may include a third sensor 122 positioned inside the container 100 in-between the first temperature sensor 110 and the second temperature sensor 112. The third sensor 122 is a temperature sensor that is configured to provide an output that is indicative of temperature of within the container that is between the first temperature sensor 110 and second temperature sensor 112. The third sensor 122 is adapted to detect the temperature of the fluid contained in the middle portion of the fluid container 100. The output of the third sensor 122 may also be utilized in the detection of movement of the thermal plane 120, based on the detected temperature of the fluid in the middle portion of the container 100. The first temperature sensor 110, the second temperature sensor 112, and the third sensor 122 may be one of a thermister, a thermocouple, PT 100 sensor, a solid state temperature sensor such as AD 500, or the like.

Although three temperature sensors are disclosed in the present embodiment, more than three temperature sensors may also be used to provide for better tracking of the movement of the thermal plane 120. More specifically, the movement of the thermal plane 120 may be more precisely tracked due to increasing number of temperature sensors. The first temperature sensor 110, the second temperature sensor 112, and the third sensor 122 are communicably coupled to the controlling unit 200.

Now referring back to FIG. 3, the controlling unit 200 (in FIG. 1) is adapted to receive inputs from the first temperature sensor 110, the second temperature sensor 112, and the third sensor 122. Further, the controlling unit 200 is adapted to receive inputs from the first temperature sensor 110, the second temperature sensor 112, and the third sensor 122 by means of various wired or wireless communication means known in the art. In one embodiment of the present disclosure, the controlling unit 200 may include a computational element 300 (as in FIG. 1). The controlling unit 200 may comprise a controller such as a microprocessor, and may be configured in the form of an IC (Integrated Circuit) chip. The controlling unit 200 may be disposed on an outside portion of the container 100. However, in other embodiment of the present disclosure, the controlling unit 200 may be positioned at another location, and may wirelessly receive inputs from the first temperature sensor 110, the second temperature sensor 112, and the third sensor 122. The controlling unit 200 may be adapted to selectively activate and deactivate one of the first heating element 106 and the second heating element 108, based on the inputs received from the first temperature sensor and the second temperature sensor.

More specifically, the controlling unit 200 is adapted to activate or turn ON the second heating element 108 when the temperature of the fluid detected by the second temperature sensor 112 is less than the pre-determined set temperature. Further, the second temperature sensor 112 is de-activated or turned off, when the temperature of the fluid detected by the second temperature sensor 112 is greater than the pre-determined set temperature. Similarly, the controlling unit 200 is adapted to activate or turn ON the first heating element 106 when the temperature of the fluid detected by the first temperature sensor 110 is less than the pre-determined set temperature. In such case before activating the first heating element, the controlling unit 200 detects with the help of the second temperature sensor 112, whether the fluid near the second heating element 108 is not too hot than the pre-determined set temperature. Further, the first heating element 106 is de-activated or turned off, when the temperature of the fluid detected by the first temperature sensor 110 is greater than the pre-determined set temperature. The controlling unit 200 may be adapted to activate or turn ON the first heating element 106 and the second heating element 108, one at a time. In one embodiment of the present disclosure, the controlling unit 200 is adapted to give priority to the second heating element 108 over the first heating element 106.

The controlling unit 200 may include a microprocessor or computational element 300 that is configured to determine an estimate of a supply time during which fluid drawn from the container is at or above a pre-determined set temperature, based on at least one input received from the sensors 110, 112, and 122, the capacity of the container 100, and the flow rate of fluid into and/or out of the container 100. In one embodiment of the present disclosure, the movement of the thermal plane 120 may indicate the flow rate of the fluid to and from the fluid container 100. The computational element 300 may be configured to detect movement of the thermal plane 120, by receiving inputs from the temperature sensors 110, 112, and 122. Additionally, when the hot fluid output flow rate changes, such as where output flow rate accelerates or retards, the computational element 300 may update the hot fluid supply time estimate based on the time required for the thermal plane 120 to move from the first temperature sensor 110 to the third sensor 122 or from the third sensor 122 to the second temperature sensor 112.

Additionally, in other embodiments of the present disclosure, the computational element 300 is configured to determine an estimate of a supply time during which fluid drawn from the container is at or above a pre-determined set temperature, based on one of the additional inputs, such as wattage of the heating elements for an electric powered fluid heater, or British Thermal Units per hour (BTU/Hr) for gas fired appliances, and temperature of cold fluid at the inlet. The wattage of the heating elements and the BTU/Hr of gas powered appliances may be constant for a particular system or may be variable for different fluid heaters.

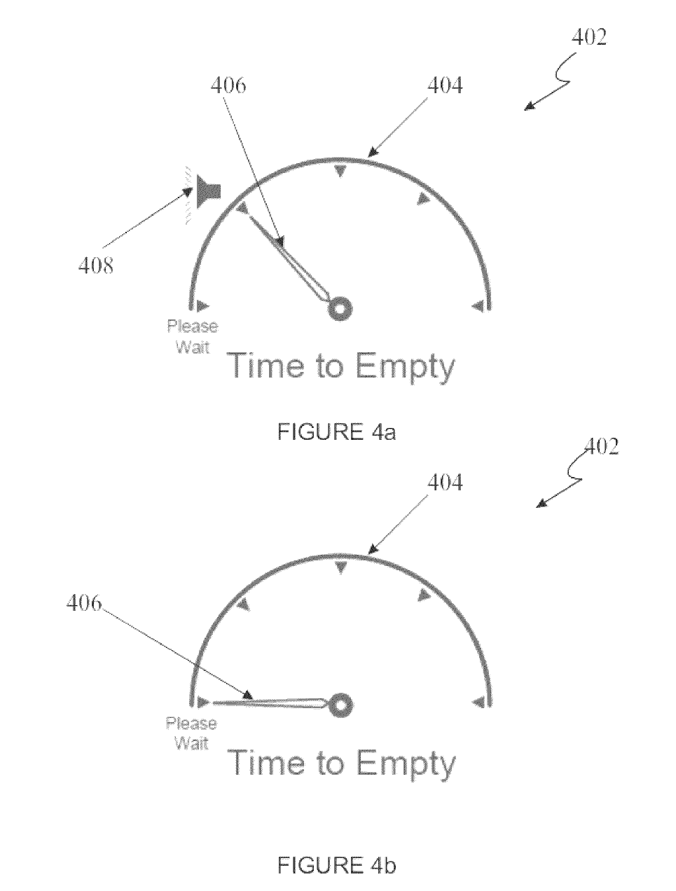

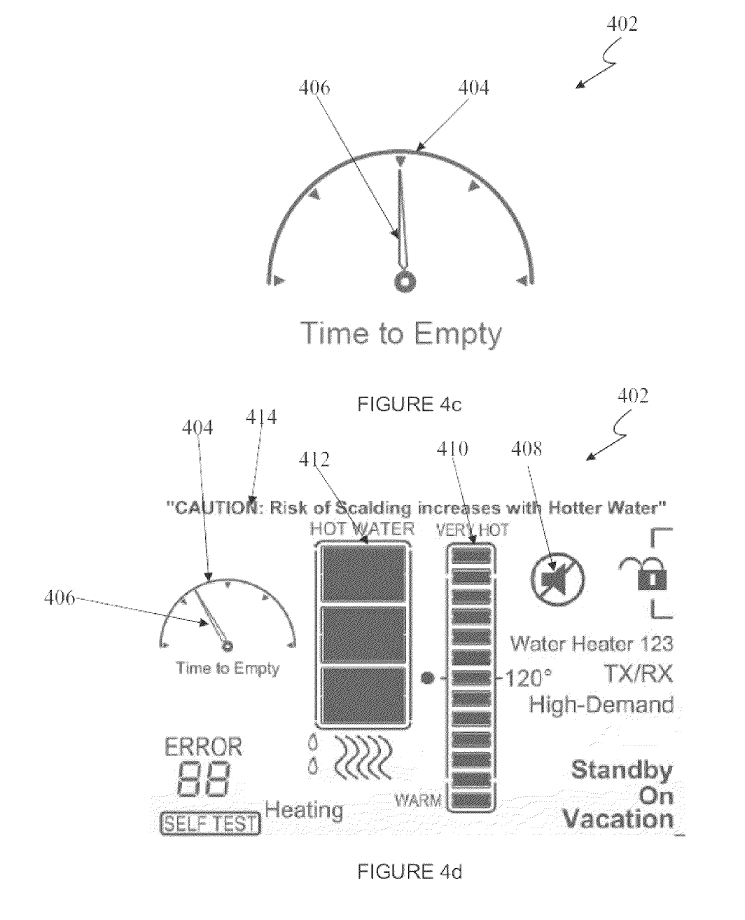

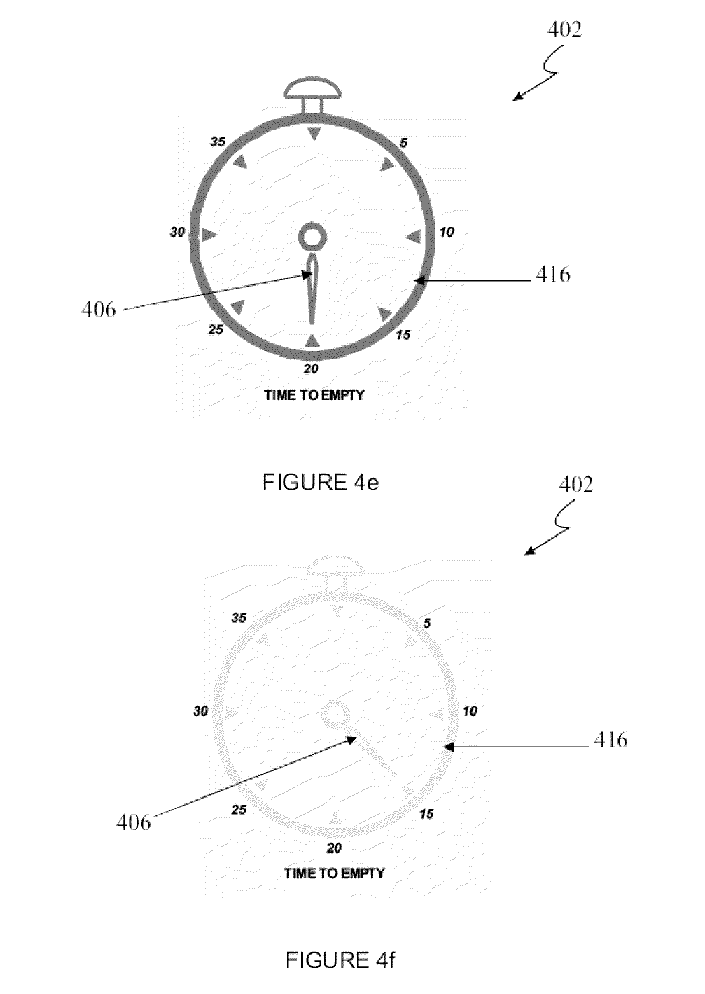

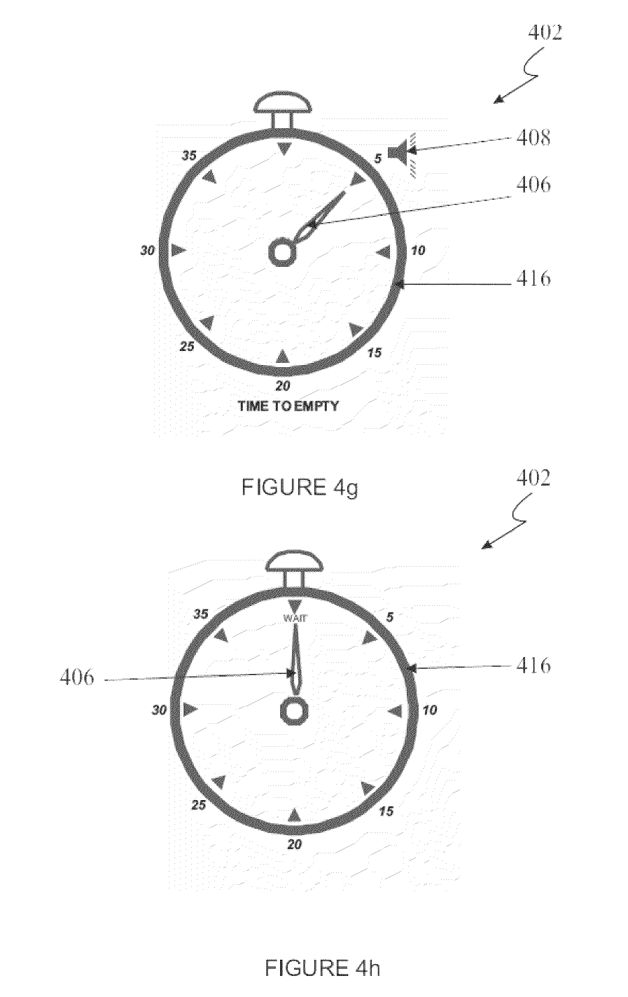

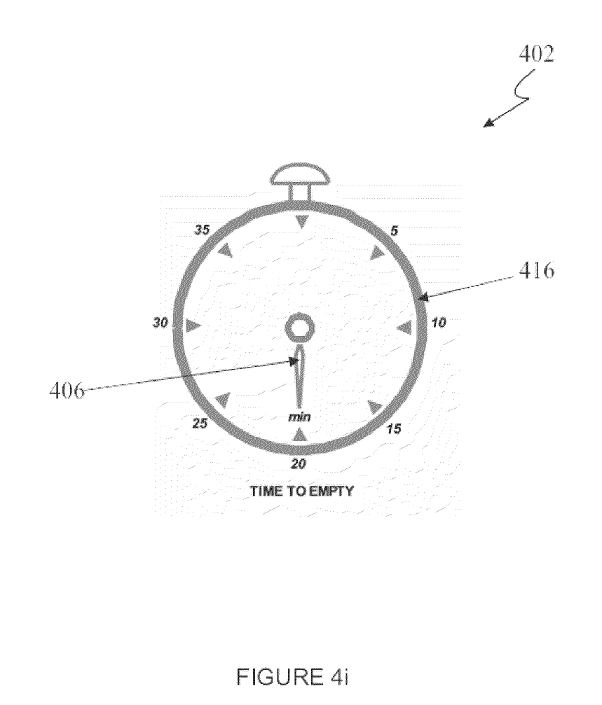

Referring to FIG. 2 and FIGS. 4a to 4i, the display means 400 is communicably coupled to the controlling unit 200 by a communication means 450 (shown in FIG. 2). In one embodiment of the present disclosure, the communication means 450 is a UART (universal asynchronous receiver/transmitter) link. However, in other embodiments of the present disclosure, the display means 400 may be communicably coupled to the controlling unit 200 by various wired or wireless communication means known in the art. The display means 400 is configured to provide or display an indication regarding the estimate of hot fluid supply time. The display means 400 includes a display screen 402 and a user interface 420. The display screen 402 is adapted to use an angular scale 404 and a pointer 406 to provide an indicating means regarding the estimate of hot fluid supply time. The pointer 406 is adapted to move angularly along the angular scale 404 for indicating hot fluid supply time at a particular instance. The user interface 420 includes a down arrow key 422, an up arrow key 424, an ON/Standby/vacation button 426, and a High-Demand key 428. The High-Demand key 428 is adapted to facilitate a temporary increase in the pre-determined set temperature.

In one embodiment of the present disclosure, the display means 400 includes a warning indication 408 (shown in FIG. 4a) for providing a warning signal when the fluid container 100 contains minimum amount of the hot fluid. In other words, the warning indication 408 is adapted to provide a warning signal when the thermal plane 120 passes the second temperature sensor 112. The warning indication 408 may be in various forms such as an alarm sound, a continuous visual blinking, and the like. The alarm sound denotes the user a warning sign regarding availability of minimum amount of hot fluid in the fluid container, without looking at the display means 400.

FIG. 4a illustrates the position of the pointer 406 when the fluid container 100 contains a minimum amount of hot fluid. The position of the pointer 406 indicates that hot fluid is available for a short duration of time and the warning signal is activated at this position of the pointer 406. Also the warning indication 408 will flash on the display screen 402. FIG. 4b illustrates a position of the pointer 406 depicting no availability of hot fluid at the pre-determined set temperature inside the fluid container 100. At such instance, a “Please wait” message may be flashed on the display screen 402. FIG. 4c illustrates a position of the pointer 406 indicating a half-way mark of the hot fluid supply time. More specifically, the position of the pointer 406 indicates that a considerable amount of time is available during which hot fluid should be available.

FIG. 4d indicates the display screen 402 of the display means 400, in another embodiment of the present disclosure. The display screen 402 of the second embodiment includes the angular scale 404, the pointer 406, the warning indication 408, a hotness indicating block 410, a hot fluid indication 412, a caution message 414 and the like. As depicted, the warning indication 408 is crossed by a diagonally placed line for indicating a de-activated state of the warning indication 408. The hotness indicating block 410 is adapted to indicate the temperature of the fluid contained inside the fluid container 100. The display screen 402 of the present disclosure is adapted to display a caution message 414 such as, “Caution: Risk of Scalding increases with hotter water”. Further, the display screen 402 of the second embodiment indicates the current status of the fluid heater 1000 by flashing one of the messages such as, “Standby”, “On” or “Vacation”, on the display screen. Further, the display screen 402 is also adapted to display an “ERROR” message thereon.

FIG. 4e indicates the display screen 402 of the display means 400, in yet another embodiment of the present disclosure. The display screen 402 as shown in the present embodiment includes a circular scale 416 and the pointer 406. The pointer 406 is adapted to be displayed angularly relative to the circular scale 416 for indicating the hot fluid supply time at a particular time. FIG. 4f illustrates a position of the pointer 406 depicting a particular time period, such as 15 minutes, for which the hot fluid may be available to the user. Further, FIG. 4g illustrates a position of the pointer 406 depicting a minimum amount of the hot fluid contained inside the fluid container 100. Also the warning indication 408 may be flashed on the display screen 402, at this position of the pointer 406. FIG. 4h illustrates a position of the pointer 406 depicting no availability of hot fluid inside the fluid container 100 at the pre-determined set temperature. At such instance, a “Wait” message may be flashed on the display screen 402. Additionally, FIG. 4i illustrates the position of the pointer 406 depicting a hot fluid supply time for standby mode during which no fluid is drawn from the fluid container 100. More specifically, the pointer 406 denotes an estimate of a hot fluid supply time when fluid is drawn from the fluid container 100 at a maximum out flow rate condition.

In one embodiment of the present disclosure, the display means 400 is a Liquid crystal Display (LCD). The Liquid crystal Display (LCD) may be adapted to display an indication of an estimate of hot fluid supply time in the form of a Dot matrix display, a seven-segment display, an Alpha numeric display, a graphic display, customized LCD modules, and the like. In another embodiment of the present disclosure, the display means 400 is a light-emitting diode (LED). The LED may be adapted to display an indication of an estimate of hot fluid supply time in the form of a seven-segment display, a bar graph display, a customized display and the like. In yet another embodiment of the present disclosure, the display means 400 is a cathode ray tube (CRT).

Further, the display means 400 may be installed inside a bathroom so that the user may get information regarding the hot fluid stock while consuming it. Alternatively, the display means 400 may be mounted outside bathroom if fluid consumption for other applications than a bath is needed.

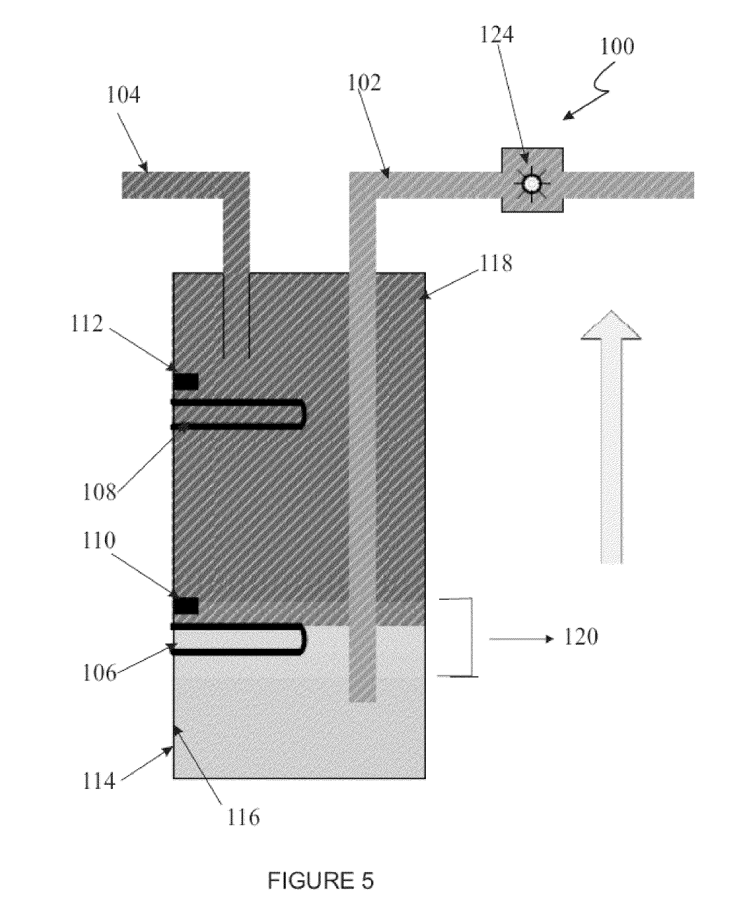

Referring to FIG. 5, in one embodiment of the present disclosure, the cold fluid inlet 102 may include a fourth sensor 124 that provides an output indicative of the cold fluid flow rate into the container 100. The fourth sensor 124 may be a turbine flow sensor, for example. The cold fluid flow rate into the fluid container 100 may be determined from the output of the fourth sensor 124, which may be an electrical signal output generated by the fourth sensor 124. The fourth sensor 124 is adapted to increase the accuracy of the fluid heater 1000. In another embodiment of the present disclosure, the fluid heater 1000 may include a fifth sensor (not shown) disposed within the hot fluid outlet that provides an output indicative of the hot fluid flow rate from the container. The hot fluid flow rate from the fluid container 100 may be determined from the output of the fifth sensor.

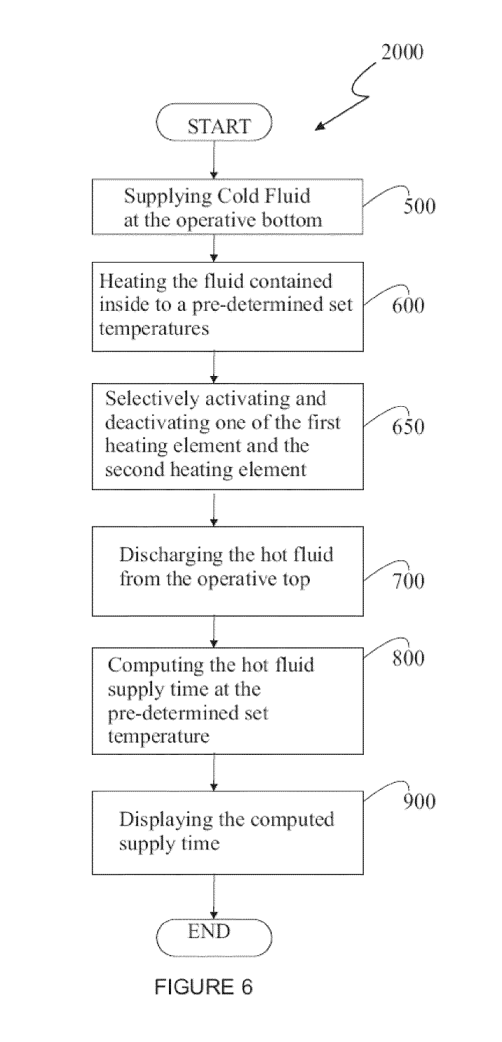

Now referring to FIG. 6, a flow chart depicting a method 2000 for evaluating and displaying hot fluid supply time from a fluid heater is depicted. At 500, cold fluid is supplied at a bottom portion 114 of a fluid container 100, such as the fluid container 100. At 600, the cold fluid supplied inside the fluid container 100 is heated to a pre-determined set temperature by a first heating element 106, and a second heating element 108. The first heating element 106 and the second heating element 108 are adapted to be turned off, when the fluid temperature inside the fluid container 100 reaches the pre-determined set temperature. Similarly, the first heating element 106 and the second heating element 108 are adapted to be turned on, when the fluid temperature inside the fluid container 100 drops below the pre-determined set temperature.

At 650, the first heating element 106 and the second heating element 108 are selectively activated and deactivated by the controlling unit 200 based on the inputs received from the first temperature sensor 110 and the second temperature sensor 112. More specifically, the controlling unit 200 is adapted to activate or turn ON the second heating element 108 when the temperature of the fluid detected by the second temperature sensor 112 is less than the pre-determined set temperature. Further, the second temperature sensor 112 is de-activated or turned off, when the temperature of the fluid detected by the second temperature sensor 112 is greater than the pre-determined set temperature. Similarly, the controlling unit 200 is adapted to activate or turn ON the first heating element 106 when the temperature of the fluid detected by the first temperature sensor 110 is less than the pre-determined set temperature. In such case before activating the first heating element, the controlling unit 200 detects, via the second temperature sensor 112, whether the fluid near the second heating element 108 is hotter than the pre-determined set temperature. Further, the first heating element 106 is de-activated or turned off, when the temperature of the fluid detected by the first temperature sensor 110 is greater than the pre-determined set temperature. The controlling unit 200 may be adapted to activate or turn ON the first heating element 106 and the second heating element 108, one at a time. In one embodiment of the present disclosure, the controlling unit 200 is adapted to give priority to the second heating element 108.

At 700, the hot fluid is discharged from the top portion 118 of the fluid container 100. Accordingly, to compensate the discharged quantity of the hot fluid, fluid at the cold fluid inlet 102 is under pressurized so that when the user draws the hot fluid from the top portion 118, the amount of the hot fluid drawn from the top portion 118 is replaced by cold fluid at the bottom portion 114.

At 800, an estimate of hot fluid supply time at the pre-determined set temperature is determined based on at least one input received from the first temperature sensor 110 and the second temperature sensor 112 disposed within the fluid container 100, the capacity of the fluid container 100, and the flow rate of fluid into or from the fluid container 100 by the computational element 300. In one embodiment of the present disclosure, the movement of the thermal plane 120 may indicate the flow rate of the fluid to and from the fluid container 100. The computational element 300 is adapted to detect movement of the thermal plane 120, based on inputs from the temperature sensors 110 and 112.

At 900, the determined estimate of hot fluid supply time is displayed on the display means 400. In one embodiment of the present disclosure, the method 2000 includes a step of providing a warning signal, such as the warning indication 408, when the fluid container 100 contains minimum amount of the hot fluid.

Additionally, in one embodiment of the present disclosure, the method 2000 includes a step of measuring temperature of the operative middle of the fluid container 100 by a third sensor, such as the third sensor 122, positioned in-between the first temperature sensor 110 and the second temperature sensor 112. More specifically, when the hot fluid output flow rate changes, such as where output flow rate accelerates or retards, the computational element 300 may update the hot fluid supply time estimate by determining the time required for the thermal plane 120 to move from the first temperature sensor 110 to the third sensor 122 or from the third sensor 122 to the second temperature sensor 112.

Further, in one embodiment of the present disclosure, the method 2000 includes a step of determining the cold fluid flow rate into the fluid container 100 based on the output of a fourth sensor, such as the fourth sensor 124. The fourth sensor 124 may be a turbine flow sensor.

Although, the present embodiments have been described with respect to storage type water heaters, the present disclosure is not limited to any particular type of fluid heaters. The principles of the present disclosure may also be used in various types of heaters such as multipoint heaters and the like.

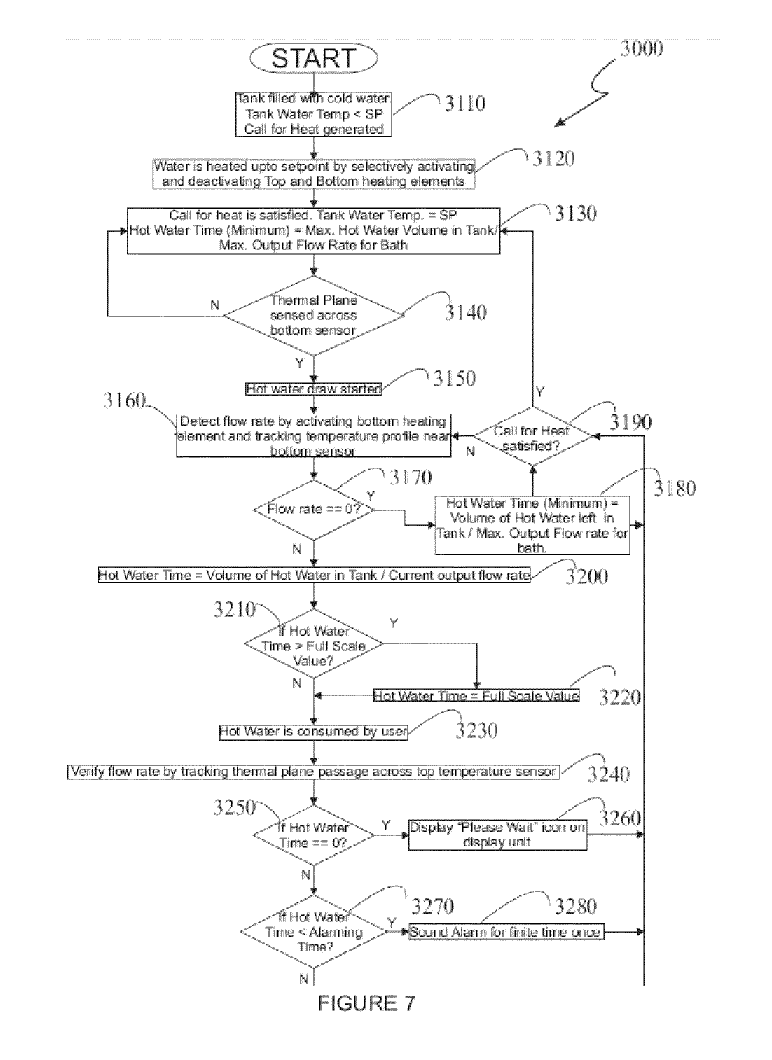

Now referring to FIG. 7, a flow chart 3000 depicting operation of the fluid heater 1000 is depicted. More specifically, the flow chart 3000 depicts method of determining or calculating an estimate of hot fluid supply time at various stages of the hot fluid supply cycle. At 3110, the fluid container 100 is filled with the cold fluid, such as water. The temperature of the cold fluid supplied is less than the pre-determined set point. Accordingly, as per the requirement of the user for the hot fluid, the user may actuate the fluid heater 1000. At 3120, one of the first heating element 106 and the second heating element 108 may be selectively activated and de-activated for heating the cold fluid to the pre-determined set point. At 3130, the hot fluid temperature contained inside the fluid container 100 is equal to the pre-determined set point. At this instance the hot fluid supply time is calculated as:

$$Hot fluid supply time ( Minimum ) = \frac{Maximum Hot fluid Volume contained inside the fluid container}{Maximum output flow rate}$$

At 3140, the movement of the thermal plane 120 across the first temperature sensor 110 is detected from the output of the first temperature sensor 110. When movement of the thermal plane is detected by the first temperature sensor 110, the flow chart 3000 proceeds to a step of 3150, otherwise, the flow chart 3000 proceeds backs to the step of 3130. At 3150, the movement of the thermal plane 120 indicates dispensing of the hot fluid from the fluid container 100. At 3160, the flow rate of the hot fluid from the fluid container 100 may be calculated by activating the first heating element 106 and tracking temperature profile near the first temperature sensor 110.

At 3170, the flow rate of the hot fluid is detected. If the flow rate of the hot fluid is equivalent to zero, the flow chart 3000 proceeds to a step of 3180, otherwise, the flow chart proceeds to a step of 3200. At 3180, the hot fluid supply time is calculated as follows:

$$Hot fluid supply time ( Minimum ) = \frac{Volume of Hot fluid left in the fluid container}{Maximum output flow rate}$$

From the step of 3180, the flow chart moves to a step 3190. At 3190, the controlling unit 200 determines whether the heat supplied is sufficient or not. If the heat supplied is sufficient, then the flow chart 3000 moves to the step of 3130 and if the heat supplied is not sufficient, then the flow chart 3000 moves to the step of 3160.

At 3200, the hot fluid supply time is determined or calculated as follows:

$$Hot fluid supply time = \frac{Volume of Hot fluid left in the fluid container}{Current output flow rate}$$

In some situations, the display means 400 may be mounted outside the bathroom where fluid consumption for applications other than a bath is needed. In such a situation, the time displayed to the user may decrease once the user starts fluid consumption for a bath as well. In such case, the user is unable to track this decrease in time, or the user may not see instantaneous time displayed over the display screen 402. In such a case, the user reads the time displayed before entering bathroom, which time corresponds to the hot water outflow at that particular instance. Thus, the user may take into consideration further consumption by the user for a bath i.e. by subtracting Offset time from Current Time.

$$Hot fluid supply time = \frac{Volume of Hot fluid left in the fluid container}{Current output flow rate + Max . Flow rate for bath}$$

At 3210, the hot fluid supply time is compared with a full scale value. If the hot fluid supply time is greater than full scale value, the flow chart 3000 moves to a step of 3220, otherwise, the flow chart 3000 moves to a step of 3230. At 3220, the hot fluid supply time is equal to the full scale value. At 3230, the hot fluid is fully consumed by the user. At 3240, the hot fluid flow rate is verified by detecting passage of the thermal plane 120 across the second temperature sensor 112. The flow rate may also be determined, when the second heating element 108 is activated, by tracking temperature profile near the second temperature sensor 112 after the thermal plane 120 has moved past the second temperature sensor 112. At 3250, the estimate of hot fluid supply time is determined. If the hot fluid supply time is zero, the flow chart moves to the step of 3260, otherwise, the flow chart moves to a step of 3270. At 3260, the controlling unit 200 facilitates the display means 400 to display the message “Please Wait” or “Wait” and then the flow chart moves to the step of 3190.

At 3270, the estimate of hot fluid supply time is compared with the alarming time. If the estimate of hot fluid supply time is less than the alarming time, the flow chart 3000 moves to the step of the 3280, otherwise, the flow chart moves to the step of 3190. At 3280, the warning indication 408 may be displayed on the display screen 402 of the display means 400. The warning indication 408 may be in various forms such as an alarm sound, a continuous visual blinking, and the like. After the step of 3280, the flow chart 3000 moves to the step of 3190.

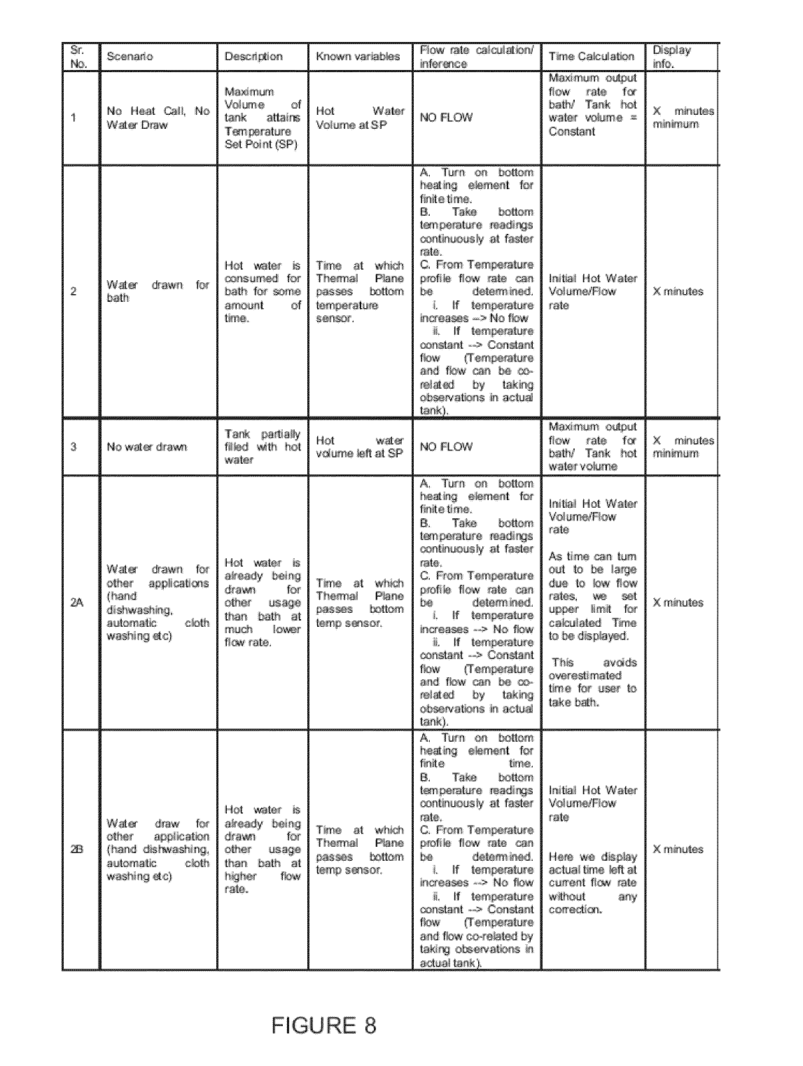

Referring to FIG. 8, a table illustrates one embodiment of a method for determining an estimate of hot fluid supply time at various operating scenarios of the fluid heater 1000. The parameter “Maximum output flow rate for bath” is constant depending upon the structural configuration of a shower outlet.

Technical Advancements and Economic Significance

The various embodiments in the present disclosure of a system for a fluid heater and method for determining and displaying an estimate of hot fluid supply time are simple in construction and easy to use. Furthermore, the fluid heater and method are adapted to evaluate and display the hot fluid supply time continuously during the utilization of the fluid heater. Accordingly, the fluid heater and the method of the present disclosure is user friendly. Moreover, the fluid heater and the method minimize wastage of power during heating process of the fluid, because the first heating element and the second heating element are turned off as the fluid in the container attains the pre-determined set temperature. Yet another object of the present disclosure is to provide a fluid heater and a method that are adapted to provide a simpler and easily understandable specification for a buyer before purchasing a fluid heater in terms of the amount of time the fluid heater is adapted to supply hot fluid at the pre-determined set temperature.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A fluid heater for determining an estimate of hot fluid supply time and displaying an indication of the estimate, the fluid heater comprising:
a) a fluid container comprising,
i. a cold fluid inlet for supplying cold fluid to a bottom portion of the container;
ii. a hot fluid outlet for discharging heated fluid from a top portion of the container;
iii. a first heating element disposed within the container and spaced from the bottom portion of the container;
iv. a second heating element disposed within the container and spaced from the top portion of the container;
v. a first temperature sensor that provides an output indicative of temperature of fluid that is in proximity to the first heating element;
vi. a second temperature sensor that provides an output indicative of temperature of fluid that is in proximity to the second heating element;
b) a controlling unit configured to receive the outputs from the first and second temperature sensors and to selectively activate and deactivate one of the first heating element and the second heating element based on the outputs from the first temperature sensor and the second temperature sensor;
c) wherein the controlling unit is configured to determine an estimate of a supply time during which fluid drawn from the container is at or above a pre-determined set temperature based on at least one output from the first or second temperature sensors, the capacity of the fluid container, and the flow rate of fluid to or from the fluid container; and
d) a display means communicably coupled to the controlling unit, the display means adapted to display the estimate of supply time.

2. The fluid heater as claimed in claim 1, further comprising a third sensor that provides an output indicative of the temperature of water within the container that is between the first temperature sensor and the second temperature sensor.

3. The fluid heater as claimed in claim 1, wherein the cold fluid inlet includes a fourth sensor that provides an output indicative of the cold fluid flow rate into the container.

4. The fluid heater as claimed in claim 3, wherein the fourth sensor is a turbine flow sensor.

5. The fluid heater as claimed in claim 3, comprising a fifth sensor that provides an output indicative of the hot fluid flow rate from the container.

6. The fluid heater as claimed in claim 1, wherein the display means is a Liquid crystal Display (LCD).

7. The fluid heater as claimed in claim 1, wherein the display means is a light-emitting diode (LED).

8. The fluid heater as claimed in claim 1, wherein the display means is a cathode ray tube (CRT).

9. The fluid heater as claimed in claim 1, wherein the fluid heater is a storage type water heater.

10. The fluid heater as claimed in claim 1, wherein the display means includes a warning indication for providing a warning signal when the fluid container contains minimum amount of hot fluid.

11. The fluid heater as claimed in claim 1, further comprising a computational element that is configured to determine an estimate of a supply time based on at least one output from the first temperature sensor or the second temperature sensor, the capacity of the fluid container, and the flow rate of fluid to or from the fluid container.

12. The fluid heater as claimed in claim 1, wherein the controlling unit further comprises a computational element that is configured to determine an estimate of a supply time.

13. A method for determining an estimate of hot fluid supply time associated with a fluid heater, the method comprising following steps:
a) supplying cold fluid through a fluid inlet to a bottom portion of a fluid container;
b) heating the fluid contained inside the container to a pre-determined set temperature by a first heating element and a second heating element;
c) selectively activating and deactivating one of the first heating element and the second heating element based on the inputs received from a first temperature sensor and a second temperature sensor by a controlling unit;
e) determining a supply time during which fluid drawn from the container is at or above a pre-determined set temperature, based on at least one input received from the first temperature sensor or the second temperature sensor, the capacity of the fluid container, and the flow rate of fluid to or from the fluid container, as determined by the controlling unit.

14. The method as claimed in claim 13, further comprising a step of displaying the determined supply time on a display means.

15. The method as claimed in claim 13 where the supply time is determined by a controlling unit that includes a computational element that is configured to determine an estimate of a supply time based on at least one output from the first temperature sensor or the second temperature sensor, the capacity of the fluid container, and the flow rate of fluid to or from the fluid container.

16. The method as claimed in claim 13, wherein the fluid heater is a storage type water heater.

17. The method as claimed in claim 13, further comprising a step of providing a warning signal when the fluid container contains minimum amount of hot fluid that is at or above a pre-determined set temperature.

18. The method as claimed in claim 13, further comprising a step of obtaining from the third temperature sensor an output that is indicative of the temperature of water within the container between the first temperature sensor and the second temperature sensor.

19. The method as claimed in claim 13, further comprising a step of determining, from the output of a sensor at the fluid inlet, the cold fluid flow rate into the fluid container.

20. The fluid heater as claimed in claim 13, further comprising a step of determining, from the output of a sensor at a fluid outlet, the hot fluid flow rate from the fluid container.
